(19) United States
(12) Patent Application Publication
(10) Pub. No.: US 2023/0077380 A1
(43) Pub. Date: Mar. 16, 2023

(54) GUIDING APPARATUS, GUIDING SYSTEM, GUIDING METHOD, AND NON-TRANSITORY COMPUTERREADABLE MEDIUM STORING PROGRAM

(71) Applicant: NEC Corporation, Minato-ku, Tokyo (JP)

(72) Inventor: Tatsuki Akutsu, Tokyo (JP)

(73) Assignee: NEC Corporation, Minato-ku, Tokyo (JP)

(21) Appl. No.: 17/908,033

(22) PCT Filed: Mar. 26, 2020
(86) PCT No.: PCT/JP2020/013718

§ 371 Date: Aug. 30, 2022

(51) Int. Cl. G01C 21/20; G06Q 10/02; G06V 40/16

(52) U.S. Cl. CPC G01C 21/206; G06Q 10/02; G06V 40/172; G06V 40/168

(57) ABSTRACT

According to an embodiment, a guiding apparatus includes acquisition means for acquiring a photograph image of a visitor taken by a photographing apparatus, face authentication means for performing face authentication on a face area of the visitor extracted from the photograph image acquired by the acquisition means, specifying means for specifying reservation information for the visitor when the face authentication by the face authentication means has succeeded, determination means for determining a place to which the visitor should be guided based on the reservation information specified by the specifying means and an arrival time of the visitor, and output means for outputting information about a route to the place to which the visitor should be guided determined by the determination means.

### TECHNICAL FIELD

The present invention relates to a guiding apparatus, a guiding system, a guiding method, and a non-transitory computer readable medium storing a program.

### BACKGROUND ART

Patent Literature 1 discloses a visitor guiding system that automatically guides, in a place a visitor has visited, such as a company, the visitor to his/her intended destination such as a meeting room, and thereby making it possible to save time and manpower.

### CITATION LIST

### Patent Literature

Patent Literature 1: Japanese Unexamined Patent Application Publication No. 2005-339232

### SUMMARY OF INVENTION

### Technical Problem

In the system disclosed in Patent Literature 1, there is a problem that even when a visitor has arrived at the destination considerably earlier than a scheduled start time of a meeting, the system guides the visitor to the reserved meeting room, so that the visitor has too much time on his/her hands before the meeting. That is, in the system disclosed in Patent Literature 1, there is a problem that it is impossible to enable a visitor effectively to use his/her spare time.

An object of the present disclosure is to provide a guiding apparatus, a guiding system, a guiding method, and a non-transitory computer readable medium storing a program capable of enabling a visitor to effectively use his/her spare time.

### Solution to Problem

A guiding apparatus according to the present disclosure includes: acquisition means for acquiring a photograph image of a visitor taken by a photographing apparatus; face authentication means for performing face authentication on a face area of the visitor extracted from the photograph image acquired by the acquisition means; specifying means for specifying reservation information for the visitor when the face authentication by the face authentication means has succeeded; determination means for determining a place to which the visitor should be guided based on the reservation information specified by the specifying means and an arrival time of the visitor; and output means for outputting information about a route to the place to which the visitor should be guided determined by the determination means.

A guiding method according to the present disclosure includes: an acquisition step of acquiring a photograph image of a visitor taken by a photographing apparatus; a face authentication step of performing face authentication on a face area of the visitor extracted from the photograph image acquired in the acquisition step; a specifying step of specifying reservation information for the visitor when the face authentication has succeeded in the face authentication step; a determination step of determining a place to which the visitor should be guided based on the reservation information specified in the specifying step and an arrival time of the visitor; and an outputting step of outputting information about a route to the place to which the visitor should be guided determined in the determination step.

A non-transitory computer readable medium according to the present disclosure stores a guiding program for causing a computer to perform: an acquisition process for acquiring a photograph image of a visitor taken by a photographing apparatus; a face authentication process for performing face authentication on a face area of the visitor extracted from the photograph image acquired in the acquisition process; a specifying process for specifying reservation information for the visitor when the face authentication has succeeded in the face authentication process; a determination process for determining a place to which the visitor should be guided based on the reservation information specified in the specifying process and an arrival time of the visitor; and an outputting process for outputting information about a route to the place to which the visitor should be guided determined in the determination process.

### Advantageous Effects of Invention

According to the present disclosure, it is possible to provide a guiding apparatus, a guiding system, a guiding method, and a non-transitory computer readable medium storing a program capable of enabling a visitor to effectively use his/her spare time.

### BRIEF DESCRIPTION OF DRAWINGS

FIG. 1 is a block diagram showing an example of a configuration of a guiding apparatus according to a first example embodiment;

FIG. 2 is a flowchart showing operations performed by the guiding apparatus shown in FIG. 1;

FIG. 3 is a block diagram showing an example of a configuration of a guiding system according to a second example embodiment;

FIG. 4 is a block diagram showing an example of a configuration of an authentication apparatus provided in the guidance system shown in FIG. 3;

FIG. 5 is a flowchart showing a flow of a face information registration process;

FIG. 6 is a flowchart showing a flow of a face authentication process;

FIG. 7 is a block diagram showing an example of a configuration of an entrance terminal provided in the guiding system shown in FIG. 3;

FIG. 8 is a block diagram showing an example of a configuration of a face authentication terminal provided in the guiding system shown in FIG. 3;

FIG. 9 is a block diagram showing an example of a configuration of a user terminal provided in the guiding system shown in FIG. 3;

FIG. 10 is a block diagram showing an example of a configuration of a guiding apparatus provided in the guiding system shown in FIG. 3;

FIG. 11 is a block diagram showing an example of a configuration of a reservation information management apparatus provided in the guiding system shown in FIG. 3;

FIG. 12 is a flowchart showing a guide process performed by the guiding system shown in FIG. 3;

FIG. 13 is an example of a floor map showing a route to a reserved meeting room; and

FIG. 14 is an example of a floor map showing a route to a waiting space.

### EXAMPLE EMBODIMENT

An example embodiment according to the present disclosure will be described hereinafter in detail with reference to the drawings. The same or corresponding reference numerals (or symbols) are assigned to the same or corresponding components/structures throughout the drawings, and redundant descriptions thereof are omitted as appropriate for clarifying the description.

### First Example Embodiment

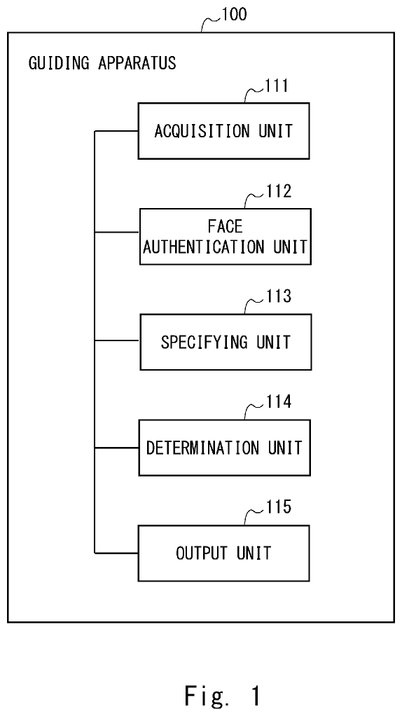

FIG. 1 is a block diagram showing an example of a configuration of a guiding apparatus 100 according to a first example embodiment.

The guiding apparatus 100 according to this example embodiment determines (i.e., selects) either one of a reserved meeting room or a waiting space as a place to which the visitor should be guided (hereinafter also referred to as a guide place, and also referred to as a reservation place) based on reservation information (a reservation time) of a meeting in which a visitor is supposed to participate and the arrival time of the visitor, and outputs information about a route to the guide place. In this way, the guiding apparatus 100 according to this example embodiment can not only guide the visitor to the reserved meeting room but also enable the visitor to effectively use his/her spare time.

As shown in FIG. 1, the guiding apparatus 100 includes an acquisition unit 111, a face authentication unit 112, a specifying unit 113, a determination unit 114, and an output unit 115. Note that the guiding apparatus 100 is connected to a network 700 (not shown). The network 700 may be a wired or wireless network. An authentication apparatus 200 and a reservation information management apparatus 600 (not shown) are also connected to the network 700.

The acquisition unit 111 acquires a photograph image of a visitor taken by a certain photographing apparatus. The certain photographing apparatus is installed, for example, in an entrance of a building or a floor thereof in which the meeting room is located.

The face authentication unit 112 performs face authentication on a face area of the visitor extracted from the photograph image acquired by the acquisition unit 111. Specifically, the face authentication unit 112 extracts the face area of the visitor from the photograph image acquired by the acquisition unit 111, and then makes (e.g., instructs) the authentication apparatus 200 perform face authentication on the extracted face area by using face feature information. Note that it is assumed that, for each of the users who are supposed to participate in the meeting, face feature information, which is a set of feature points in the face area of the user, is already stored in the authentication apparatus 200.

When the face authentication of the visitor by the face authentication unit 112 has succeeded, the specifying unit 113 specifies (i.e., retrieves) reservation information for the meeting in which the visitor is supposed to participate from among a plurality of pieces of reservation information stored in the reservation information management apparatus 600. Note that, as each of the plurality of pieces of information, a date of a meeting, a start time thereof, an end time thereof, a meeting room ID, user IDs of participants, and the like are associated with each other and are registered in the reservation information management apparatus 600.

It is assumed that, for example, the visitor is a participant UA1, and information including a start time of 10:00, an end time of 11:00, a meeting room R1 as a place where the meeting is held, and participants UA1, UA2 and UA3 is registered as reservation information X1 in the reservation information management apparatus 600. In this case, when the face authentication of the visitor UA1 by the face authentication unit 112 has succeeded, the specifying unit 113 specifies, as the aforementioned reservation information, the reservation information X1 for the meeting in which the visitor UA1 is supposed to participate.

The determination unit 114 determines a guide place (i.e., a place to which the visitor should be guided) based on the reservation information specified by the specifying unit 113 and the arrival time of the visitor. Specifically, when the difference between the start time of the meeting in which the visitor is supposed to participate and the arrival time of the visitor is shorter than a predetermined time, the determination unit 114 determines the reserved meeting room as the guide place. On the other hand, when the difference between the start time of the meeting in which the visitor is supposed to participate and the arrival time of the visitor UA1 is equal to or longer than the predetermined time, the determination unit 114 determines the waiting space as the guide place.

For example, when the predetermined time is set to 15 minutes and the arrival time of the visitor UA1 is 9:50, the difference between the start time of the meeting (10:00) and the arrival time of the visitor UA1 (9:50) is shorter than the predetermined time (15 minutes). Therefore, the determination unit 114 determines the reserved meeting room R1 as the guide place of the visitor UA1. On the other hand, when the predetermined time is set to 15 minutes and the arrival time of the visitor UA1 is 9:40, the difference between the start time of the meeting (10:00) and the arrival time of the visitor UA1 (9:40) is equal to or longer than the predetermined time (15 minutes). Therefore, the determination unit 114 determines the waiting space R5 as the guide place of the visitor UA1.

The output unit 115 outputs information about a route to the guide place determined by the determination unit 114. For example, when the guide place determined by the determination unit 114 is the meeting room R1, the output unit 115 makes (e.g., instructs) a display device display a floor map on which a route from the entrance of the building or the floor to the meeting room R1 is indicated. Alternatively, when the guide place determined by the determination unit 114 is the waiting space R5, the output unit 115 makes (e.g., instructs) the display device display a floor map on which a route from the entrance of the building or the floor to the waiting space R5 is indicated. The display device is, for example, a digital signage device, a user terminal, or the like installed at the entrance of the building or the floor.

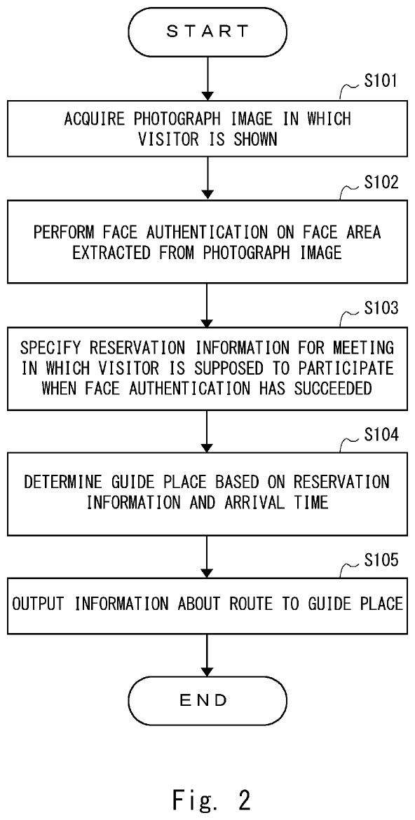

FIG. 2 is a flowchart showing operations performed by the guiding apparatus 100.

Firstly, the acquisition unit 111 acquires a photograph image of a visitor taken by a certain photographing apparatus (Step S101).

After that, the face authentication unit 112 performs face authentication on a face area of the visitor extracted from the photograph image acquired by the acquisition unit 111 (Step S102). Specifically, the face authentication unit 112 extracts the face area of the visitor from the photograph image acquired by the acquisition unit 111, and then makes (e.g., instructs) the authentication apparatus 200 perform face authentication on the extracted face area by using face feature information.

After that, when the face authentication of the visitor by the face authentication unit 112 has succeeded, the specifying unit 113 specifies reservation information for the meeting in which the visitor is supposed to participate from among a plurality of pieces of reservation information stored in the reservation information management apparatus 600 (Step S103).

After that, the determination unit 114 determines a guide place (i.e., a place to which the visitor should be guided) based on the reservation information specified by the specifying unit 113 and the arrival time of the visitor (Step S104). Specifically, when the difference between the start time of the meeting in which the visitor is supposed to participate and the arrival time of the visitor is shorter than a predetermined time, the determination unit 114 determines the reserved meeting room as the guide place. On the other hand, when the difference between the start time of the meeting in which the visitor is supposed to participate and the arrival time of the visitor is equal to or longer than the predetermined time, the determination unit 114 determines the waiting space as the guide place.

As described above, the guiding apparatus 100 according to this example embodiment determines (i.e., selects) either one of the reserved meeting room or the waiting space as the guide place based on the reservation information for the meeting in which the visitor is supposed to participate and the arrival time of the visitor, and outputs information about the route to the guide place. In this way, the guiding apparatus 100 according to this example embodiment can not only guide the visitor to the reserved meeting room but also enable the visitor to effectively use his/her spare time.

Note that the guiding apparatus 100 includes a processor, a memory, and a storage device (not shown). Further, in the storage device, a computer program in which the processes of the guiding method according to this example embodiment are implemented is stored. Further, the processor loads the computer program from the storage device into the memory and executes the loaded computer program. In this way, the processor implements the functions of the acquisition unit 111, the face authentication unit 112, the specifying unit 113, the determination unit 114, and the output unit 115.

Alternatively, each of the acquisition unit 111, the face authentication unit 112, the specifying unit 113, the determination unit 114, and the output unit 115 may be implemented by dedicated hardware. Alternatively, some or all of the components of each apparatus may be implemented by general-purpose or dedicated circuitry, a processor, or a combination thereof. These components may be implemented by using a single chip or may be implemented by using a plurality of chips connected through a bus. Some or all of the components of each apparatus may be implemented by a combination of the above-described circuitry or the like and the program. Further, a CPU (Central Processing Unit), a GPU (Graphics Processing Unit), an FPGA (Field-Programmable Gate Array), or the like can be used as the processor.

Further, in the case where some or all of the components of the guiding apparatus 100 are implemented by a plurality of information processing apparatuses, circuitry, or the like, the plurality of information processing apparatuses, circuitry, or the like may be disposed in one place in a concentrated manner or in a plurality of places in a distributed manner. For example, the information processing apparatus, circuitry, or the like may be implemented in a form in which the components or the like are connected through a communication network, i.e., may be implemented as a client-server system, a cloud computing system, or the like. Further, the functions of the guiding apparatus 100 may be provided in the form of SaaS (Software as a Service).

### (Modified Example of Guiding Apparatus 100)

Although this example embodiment has been described by using a case where the authentication apparatus 200 is provided outside the guiding apparatus 100 as an example, the configuration of the present invention is not limited to this example. That is, the functions of the authentication apparatus 200 may be provided inside the guiding apparatus 100. In this case, the face feature information of each of users who are supposed to participate in the meeting is stored, for example, in a storage unit (not shown) provided in the guiding apparatus 100.

Note that the face authentication unit 112 extracts a face area of the visitor from the photograph image acquired by the acquisition unit 111, and then performs face authentication on the extracted face area by using the face feature information stored in the storage unit.

The rest of the configuration and operations of the modified example of the guiding apparatus 100 is similar to those of the guiding apparatus 100 shown in FIG. 1, and therefore the description thereof is omitted.

The modified example of the guiding apparatus 100 can also provide advantageous effects equivalent to those provided by the guiding apparatus 100 shown in FIG. 1.

### Second Example Embodiment

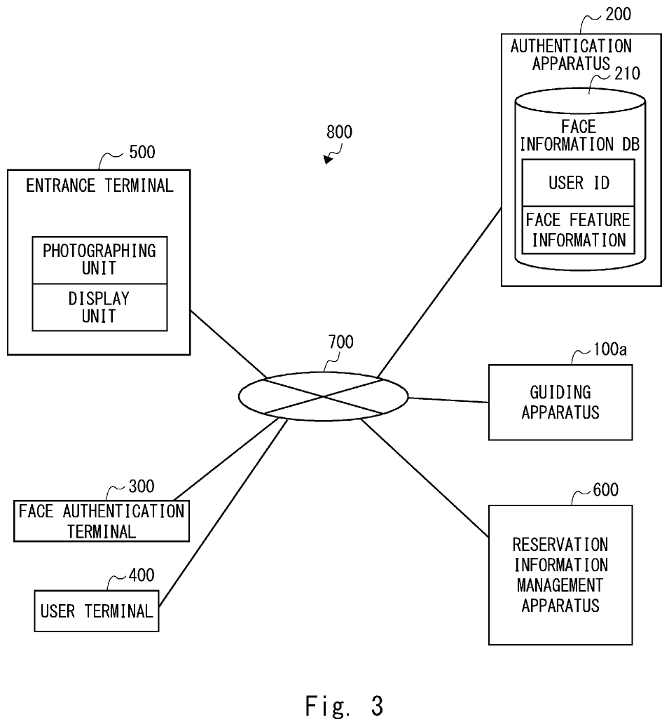

FIG. 3 is a block diagram showing an example of a configuration of a guiding system 800 according to a second example embodiment. The guiding system 800 includes a guiding apparatus 100a, which is a specific example of the guiding apparatus 100, an authentication apparatus 200, a face authentication terminal 300, a user terminal 400, an entrance terminal 500, a reservation information management apparatus 600, and a network 700. The guiding apparatus 100a, the authentication apparatus 200, the face authentication terminal 300, the user terminal 400, the entrance terminal 500, and the reservation information management apparatus 600 are connected to each other through the network 700.

Note that, in this example embodiment, it is assumed that face feature information of each of users who are supposed to participate in the meeting is already registered in the authentication apparatus 200.

### (Overview of Each Apparatus in Guiding System 800)

Firstly, an outline of each of apparatuses included in the guiding system 800 will be described.

The guiding apparatus 100a determines (i.e., selects) either one of the reserved meeting room or the waiting space as the guide place based on the reservation information for the meeting in which the visitor is supposed to participate and the arrival time of the visitor, and outputs information about a route to the guide place. Since the outline of the guiding apparatus 100a is similar to that of the guiding apparatus 100, the description thereof will be omitted.

The authentication apparatus 200 includes a face information DB 210. In the face information DB 210, user IDs and pieces of face feature information of users are stored in association with each other. The face information DB 210 is also referred to as a storage unit. Further, the authentication apparatus 200 compares, in response to a face authentication request received from the outside thereof, a face image or face feature information contained in this request with each of a plurality of pieces of face feature information of a plurality of users, and returns the result of the comparisons to the entity that has issued the request.

Each of the face authentication terminal 300 and the user terminal 400 is an apparatus that requests, prior to the face authentication of the user is performed by the face authentication unit 112 of the guiding apparatus 100a, the registration of face feature information extracted from a face image of a user who is supposed to participate in the meeting in the face information DB 210.

The face authentication terminal 300 takes a registration image of a user who is supposed to participate in the meeting which will be used for the face authentication of the user. The face authentication terminal 300 transmits the registration image to the authentication apparatus 200, and thereby requests the authentication apparatus 200 to register face information. Note that the face authentication terminal 300 may transmit face feature information extracted from the registration image to the authentication apparatus 200, and thereby requests the authentication apparatus 200 to register face information.

The user terminal 400 is a terminal carried by a user who is supposed to participate in the meeting. The user terminal 400 is, for example, a cellular phone terminal, a smart phone, a tablet-type terminal, a PC (Personal Computer) with a camera disposed therein or connected thereto, or the like. The user terminal 400 transmits the registration image of each of users, which will be used for the face authentication of the user, to the authentication apparatus 200, and thereby requests the authentication apparatus 200 to register face information. Note that the user terminal 400 may transmit face feature information extracted from the registration image to the authentication apparatus 200, and thereby requests the authentication apparatus 200 to register face information.

Note that the terminal from which a request for registration of face information is made may be only one of the face authentication terminal 300 or the user terminal 400.

The entrance terminal 500, which is installed, for example, in the entrance of the building or the floor in which the meeting room is located, takes an image of a visitor who is supposed to participate in the meeting and transmits the taken image to the guiding apparatus 100a for face authentication, and outputs, when the face authentication has succeeded, information about a route to the guide place (the meeting room, the waiting space, or the like).

In the reservation information management apparatus 600, a plurality of pieces of reservation information for a plurality of meetings are registered. For example, in the reservation information management apparatus 600, for each of the meetings, a date of the meeting, a start time thereof, an end time thereof, a meeting room ID, and user IDs of participants are registered as reservation information. In the guiding apparatus 100a, when the face authentication of the visitor by the face authentication unit 112 has succeeded, the specifying unit 113 specifies reservation information for the meeting in which the visitor is supposed to participate from among a plurality of pieces of reservation information stored in the reservation information management apparatus 600.

### (Details of Each Apparatus in Guiding System 800)

Next, details of each of apparatuses included in the guiding system 800 will be described.

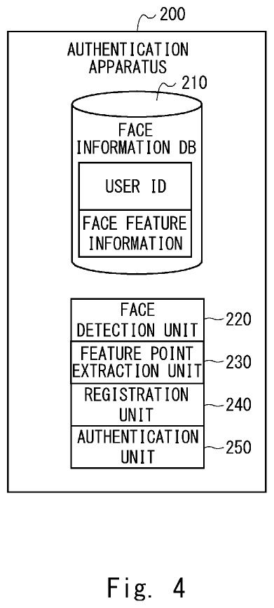

FIG. 4 is a block diagram showing an example of a configuration of the authentication apparatus 200.

As shown in FIG. 4, the authentication apparatus 200 includes, in addition to the face information DB 210, a face detection unit 220, a feature point extraction unit 230, a registration unit 240, and an authentication unit 250.

The face detection unit 220 detects a face area of a user included (i.e., shown) in the registration image for registering face information, and outputs the detected face area to the feature point extraction unit 230. The feature point extraction unit 230 extracts feature points from the face area of the user detected by the face detection unit 220, and outputs face feature information, which is a set of extracted feature points, to the registration unit 240. The registration unit 240 newly issues a user ID when the face feature information is registered. The registration unit 240 registers the issued user ID and the face feature information extracted from the registration image in the face information DB 210 while associating them with each other.

Further, the feature point extraction unit 230 extracts feature points from the face image included (i.e., shown) in the photograph image of the visitor received from the guiding apparatus 100a, and outputs face feature information, which is a set of the extracted feature points, to the authentication unit 250. Note that the photograph image of the visitor is, for example, a photograph image taken by a photographing unit 510 of the entrance terminal 500.

The authentication unit 250 compares the face feature information extracted from the photograph image of the visitor with face feature information registered in the face information DB 210. The authentication unit 250 returns information indicating whether or not these two pieces of face feature information match each other to the guiding apparatus 100a. The match/mismatch between the two pieces of face feature information corresponds to the success/failure of the authentication.

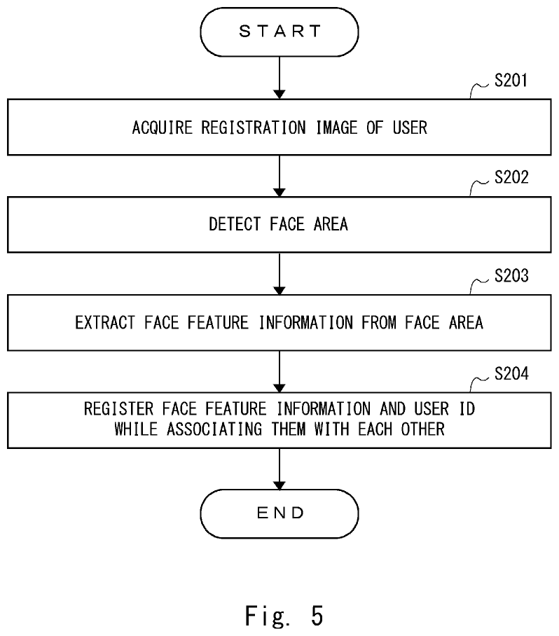

FIG. 5 is a flowchart showing a flow of a face information registration process performed by the authentication apparatus 200.

As shown in FIG. 5, firstly, the authentication apparatus 200 acquires a registration image contained in a face information registration request (Step S201). For example, the authentication apparatus 200 receives a face information registration request from either the face authentication terminal 300 or the user terminal 400 through the network 700.

After that, the face detection unit 220 detects a face area included (i.e., shown) in the registration image (Step S202). After that, the feature point extraction unit 230 extracts feature points from the face area detected by the face detection unit 220, and outputs face feature information, which is a set of feature points, to the registration unit 240 (Step S203).

After that, the registration unit 240 issues a user ID, and registers the user ID and the face feature information in the face information DB 210 while associating them with each other (Step S204). Note that the authentication apparatus 200 may receive face feature information from either the face authentication terminal 300 or the user terminal 400, and register the received face feature information in the face information DB 210 while associating it with the user ID.

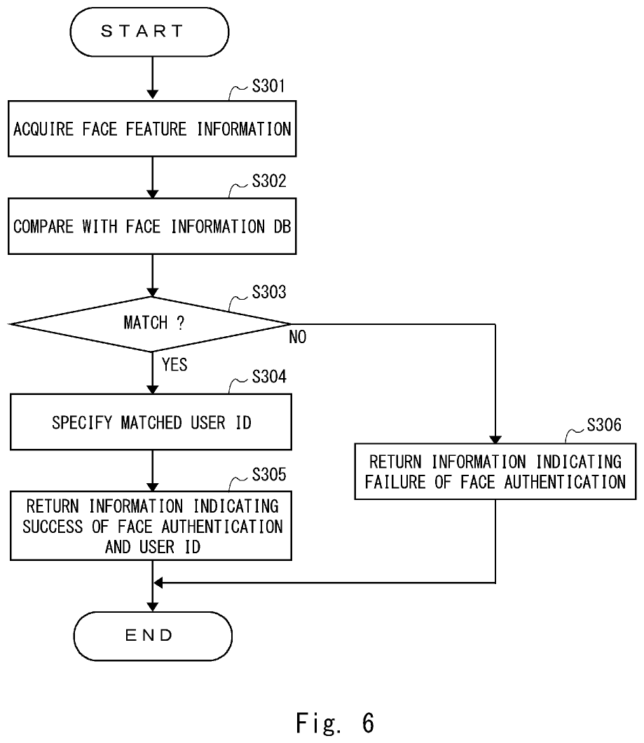

FIG. 6 is a flowchart showing a flow of a face authentication process performed by the authentication apparatus 200. As shown in FIG. 6, firstly, the feature point extraction unit 230 extracts feature points from a face image included (i.e., shown) in the photograph image of the visitor received from the guiding apparatus 100a, and outputs face feature information, which is a set of the feature points, to the authentication unit 250 (Step S301). Note that the authentication apparatus 200 may receive the face feature information from the guiding apparatus 100a.

After that, the authentication unit 250 compares the face feature information extracted from the photograph image of the visitor with face feature information registered in the face information DB 210 (Step S302). When these pieces of face feature information match each other (Yes in Step S303), the authentication unit 250 specifies the user ID of the user of which the pieces of face feature information match each other (Step S304), and returns information indicating that the face authentication has succeeded and the specified user ID to the guiding apparatus 100a (Step S305). On the other hand, when the pieces of face feature information do not match each other (No in Step S303), the authentication unit 250 returns information indicating that the face authentication has failed to the guiding apparatus 100a (step S306).

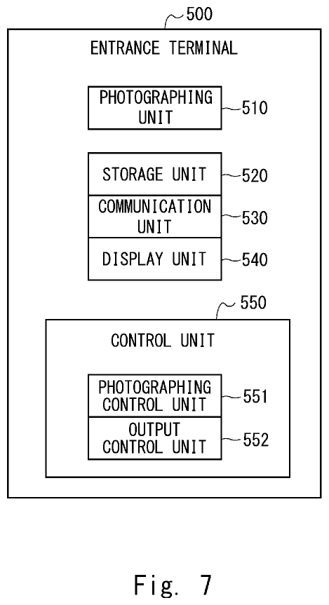

FIG. 7 is a block diagram showing an example of a configuration of the entrance terminal 500.

As shown in FIG. 7, the entrance terminal 500 includes a photographing unit 510, a storage unit 520, a communication unit 530, a display unit 540, and a control unit 550.

The storage unit 520 is a storage device in which a program(s) for implementing the functions of the entrance terminal 500 is stored. The communication unit 530 is a communication interface with the network 700. The display unit 540 is a display device such as a digital signage device. The control unit 550 controls hardware of the entrance terminal 500. Specifically, the control unit 550 includes a photographing control unit 551 and an output control unit 552.

The photographing control unit 551 photographs a visitor who has arrived at the entrance of the building by using the photographing unit 510. Then, the photographing control unit 551 transmits the photograph image of the visitor taken by the photographing unit 510 to the guiding apparatus 100a through the network 700. The output control unit 552 makes (e.g., instructs) the display unit 540 display a floor map (information indicating a route to the guide place) that has been received from the guiding apparatus 100a through the network 700 and the communication unit 530. Note that the display unit 540 is, for example, a digital signage device. However, the display unit 540 may be a display unit of a user terminal carried by the visitor.

Note that the entrance terminal 500 may be connected to a gate for controlling comings and goings of people to and from the building or the floor. In such a case, the entrance terminal 500 cancels the restriction of the gate provided on the route from the entrance of the building or the floor to the guide place in response to admission (i.e., permission) issued from a visiting support apparatus.

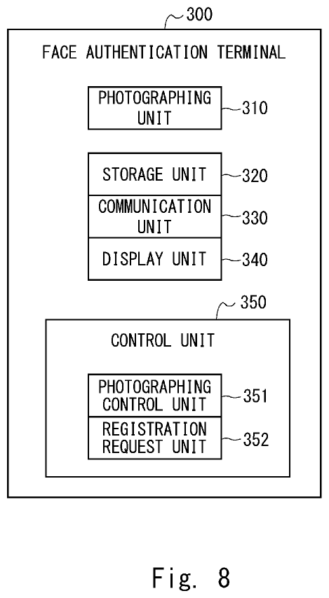

FIG. 8 is a block diagram showing an example of a configuration of the face authentication terminal 300.

As shown in FIG. 8, the face authentication terminal 300 includes a photographing unit 310, a storage unit 320, a communication unit 330, a display unit 340, and a control unit 350.

The storage unit 320 is a storage device in which a program(s) for implementing the functions of the face authentication terminal 300 is stored. The communication unit 330 is a communication interface with the network 700. The display unit 340 is a display device such as a monitor. The control unit 350 controls hardware of the face authentication terminal 300. Specifically, the control unit 350 includes a photographing control unit 351 and a registration request unit 352.

The photographing control unit 351 takes a registration image of a user who is supposed to participate in the meeting by using the photographing unit 310. The registration image is an image including at least a face area of the user. The registration request unit 352 transmits a face information registration request containing the registration image to the authentication apparatus 200 through the network 700.

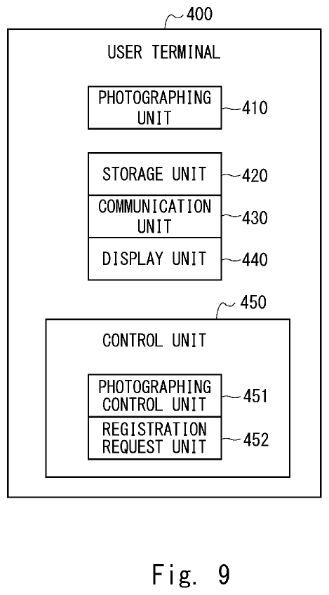

FIG. 9 is a block diagram showing an example of a configuration of the user terminal 400.

As shown in FIG. 9, the user terminal 400 includes a photographing unit 410, a storage unit 420, a communication unit 430, a display unit 440, and a control unit 450.

The storage unit 420 is a storage device in which a program(s) for implementing the functions of the user terminal is stored. The communication unit 430 is a communication interface with the network 700. The display unit 440 is a display device such as a monitor. The controller 450 controls hardware of the user terminal 400. Specifically, the control unit 450 includes a photographing control unit 451 and a registration request unit 452.

The photographing control unit 451 takes a registration image of a user who is supposed to participate in the meeting by using the photographing unit 410. The registration request unit 452 transmits a face information registration request containing the registration image to the authentication apparatus 200 through the network 700.

Each of the face authentication terminal 300 and the user terminal 400 has a function of requesting the registration of face information as described above. Although a flow of a face information registration process performed by the user terminal 400 will be briefly described hereinafter, a similar process may be performed by the face authentication terminal 300.

In the user terminal 400, the photographing control unit 451 first takes a registration image of a user who is supposed to participate in the meeting by using the photographing unit 410. After that, the registration request unit 452 transmits a face information registration request containing the registration image to the authentication apparatus 200 through the network 700. Note that the registration request unit 452 may transmit a face information registration request containing face feature information extracted from the registration image to the authentication apparatus 200. After that, the registration request unit 452 receives a result of authentication from the authentication apparatus 200.

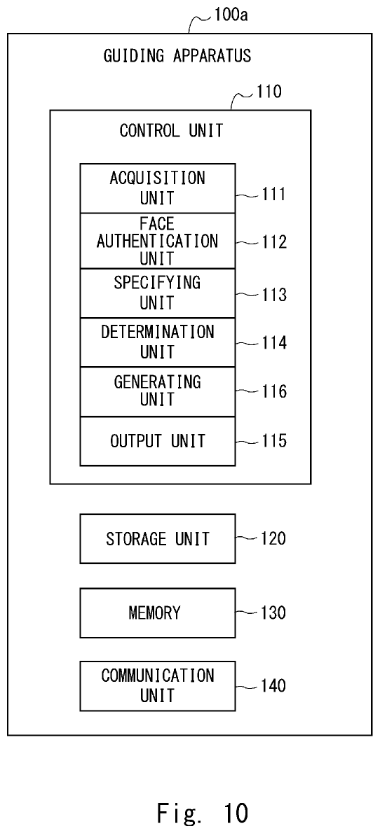

FIG. 10 is a block diagram showing an example of a configuration of the guiding apparatus 100a.

As shown in FIG. 10, the guiding apparatus 100a is, for example, a server apparatus implemented by a computer, and includes a control unit 110, a storage unit 120, a memory 130, and a communication unit 140.

The storage unit 120 is a storage device in which a program(s) for implementing the functions of the guiding apparatus 100a is stored. The memory 130 is a storage area for temporarily storing processing data or the like of the control unit 110, and is, for example, a volatile storage device such as a RAM. The communication unit 140 is a communication interface with the network 700.

The control unit 110 is a control apparatus that controls operations performed by the guiding apparatus 100a, and is, for example, a processor such as a CPU. The control unit 110 loads a program from the storage unit 120 into the memory 130, and executes the loaded program. In this way, the control unit 110 implements the functions of the acquisition unit 111, the face authentication unit 112, the specifying unit 113, the determination unit 114, the output unit 115, and a generation unit 116.

The acquisition unit 111 acquires the photograph image of the visitor taken by the photographing unit 510 of the entrance terminal 500.

The face authentication unit 112 performs face authentication on the face area of the visitor extracted from the photograph image acquired by the acquisition unit 111.

Specifically, the face authentication unit 112 extracts a face area of the visitor from the photograph image acquired by the acquisition unit 111, and then makes (e.g., instructs) the authentication apparatus 200 perform face authentication on the extracted face area by using face feature information. Note that the face authentication unit 112 may include face feature information extracted from the acquired photograph image in the face authentication request. Further, the face authentication unit 112 receives the result of the face authentication from the authentication apparatus 200. When the face authentication has succeeded, the user ID of the visitor is contained in the result of the face authentication.

Note that, as described above, the function of the authentication apparatus 200 may be provided inside the guiding apparatus 100a.

When the face authentication of the visitor by the face authentication unit 112 has succeeded, the specifying unit 113 specifies reservation information for the meeting in which the visitor is supposed to participate from among a plurality of pieces of reservation information stored in the reservation information management apparatus 600. Note that, as each of the plurality of pieces of information, a date of a meeting, a start time thereof, an end time thereof, a meeting room ID, user IDs of participants, and the like are associated with each other and are registered in the reservation information management apparatus 600.

The determination unit 114 determines a guide place (i.e., a place to which the visitor should be guided) based on the reservation information specified by the specifying unit 113 and the arrival time of the visitor. Specifically, when the difference between the start time of the meeting in which the visitor is supposed to participate and the arrival time of the visitor is shorter than a predetermined time, the determination unit 114 determines the reserved meeting room as the guide place. On the other hand, when the difference between the start time of the meeting in which the visitor is supposed to participate and the arrival time of the visitor is equal to or longer than the predetermined time, the determination unit 114 determines the waiting space as the guide place. Note that the arrival time of the visitor may be a time when the visitor is photographed by the photographing unit 510 of the entrance terminal 500, or a time when the face authentication of the visitor is performed by the face authentication unit 112.

The generation unit 116 generates a floor map on which, for example, a route from the entrance of the building or the floor, in which the entrance terminal 500 is installed, to the guide place determined by the determination unit 114 is indicated.

The output unit 115 makes (e.g., instructs), for example, the display unit 540 of the entrance terminal 500 display the floor map on which the route from the place where the entrance terminal 500 is installed to the guide place determined by the determination unit 114 is indicated.

For example, when the guide place determined by the determination unit 114 is a meeting room, the output unit 115 makes (e.g., instructs) the display unit 540 of the entrance terminal 500 display a floor map on which a route from the place where the entrance terminal 500 is installed to the meeting room is indicated. Alternatively, when the guide place determined by the determination unit 114 is a waiting space, the output unit 115 makes (e.g., instructs) the display unit 540 of the entrance terminal 500 display a floor map on which a route from the entrance of the building or the floor to the waiting space is indicated.

Note that the output unit 115 may make (e.g., instruct) the display unit 440 of the user terminal 400 display the floor map on which the route to the guide place is indicated.

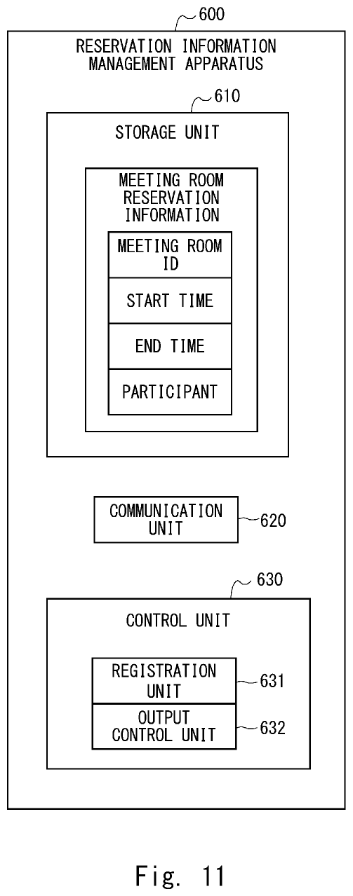

FIG. 11 is a block diagram showing an example of a configuration of the reservation information management apparatus 600. As shown in FIG. 11, the reservation information management apparatus 600 is, for example, a server apparatus implemented by a computer, and includes a storage unit 610, a communication unit 620, and a control unit 630.

The storage unit 610 is a storage device in which a program(s) for implementing the functions of the reservation information management apparatus 600 are stored, and reservation information such as information about a meeting room is stored. As described above, the meeting room reservation information is information in which a date of a meeting, a start time thereof, an end time thereof, a meeting room ID, user IDs of participants, and the like are associated with each other. The communication unit 620 is a communication interface with the network 700. The control unit 630 is a control apparatus that controls operations performed by the reservation information management apparatus 600, and is, for example, a processor such as a CPU. The control unit 630 loads a program from the storage unit 610 into a memory (not shown), and executes the loaded program. In this way, the control unit 630 implements the functions of a registration unit 631 and an output control unit 632.

The registration unit 631 receives a set of a date of a meeting, a start time thereof, an end time thereof, a meeting room ID, user IDs of participants, and the like from the user terminal 400 or the like, and stores them as reservation information in the storage unit 610 while associating them with each other.

The output control unit 632 extracts (i.e., retrieves) reservation information for the meeting in which the visitor is supposed to participate from among a plurality of pieces of reservation information stored in the storage unit 610 based on the information about the visitor that has been received from the guiding apparatus 100a through the network 700, and transmits the extracted reservation information to the guiding apparatus 100a through the network 700.

Note that the function of the reservation information management apparatus 600 may be provided inside the guiding apparatus 100a. In other words, the reservation information stored in the storage unit 610 of the reservation information management apparatus 600 may be stored in the storage unit 120 of the guiding apparatus 100a.

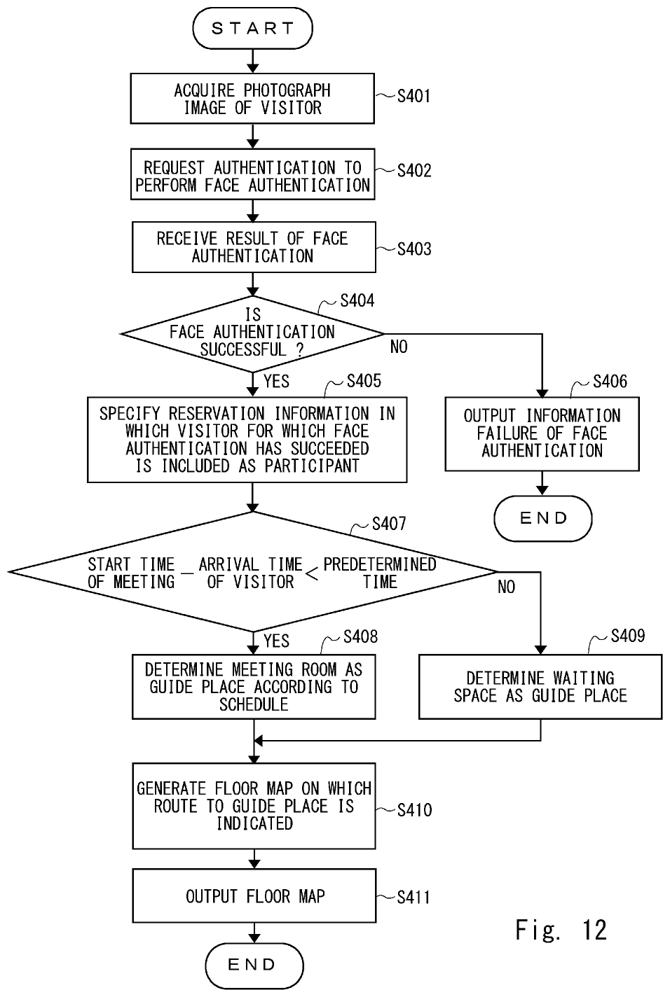

FIG. 12 is a flowchart showing operations performed by guiding system 800.

Firstly, the acquisition unit 111 acquires a photograph image of a visitor taken by the photographing unit 510 of the entrance terminal 500 (Step S401).

After that, the face authentication unit 112 extracts a face area of the visitor from the photograph image acquired by the acquisition unit 111, and then makes (e.g., instructs) the authentication apparatus 200 perform face authentication on the extracted face area by using face feature information (Step S402). Then, the face authentication unit 112 receives the result of the face authentication from the authentication apparatus 200 (Step S403).

When the face authentication of the visitor by the face authentication unit 112 has failed (No in Step S404), the output unit 115 makes (e.g., instructs), for example, the display unit 540 of the entrance terminal 500 display information indicating that the face authentication has failed (Step S406).

On the other hand, when the face authentication of the visitor by the face authentication unit 112 has succeeded (Yes in Step S404), the specifying unit 113 specifies reservation information for the meeting in which the visitor is supposed to participate from among a plurality of pieces of reservation information stored in the reservation information management apparatus 600 (Step S405).

After that, the determination unit 114 determines a guide place based on the reservation information specified by the specifying unit 113 and the arrival time of the visitor.

For example, when the difference between the start time of the meeting in which the visitor is supposed to participate and the arrival time of the visitor is shorter than a predetermined time (Yes in Step S407), the determination unit 114 determines the reserved meeting room (e.g., the meeting room R1) as the guide place (Step S408). On the other hand, when the difference between the start time of the meeting in which the visitor is supposed to participate and the arrival time of the visitor is equal to or longer than the predetermined time (No in Step S407), the determination unit 114 determines the waiting space (e.g., the waiting space R5) as the guide place (Step S409).

After that, the generation unit 116 generates a floor map on which, for example, a route from the entrance of the building or the floor, in which the entrance terminal 500 is installed, to the guide place determined by the determination unit 114 is indicated (Step S410).

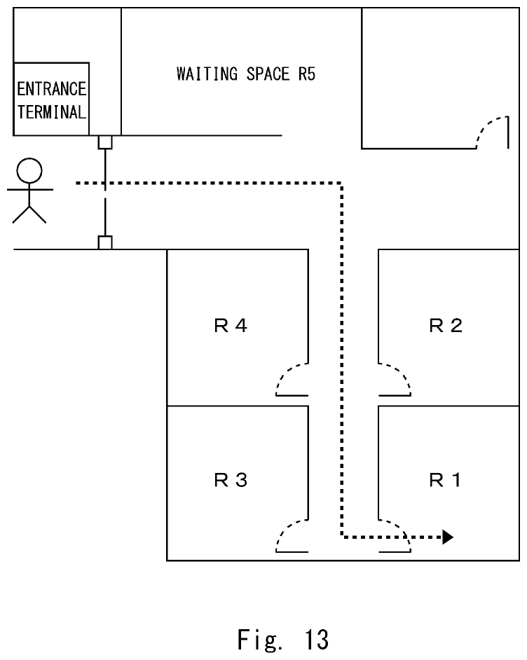

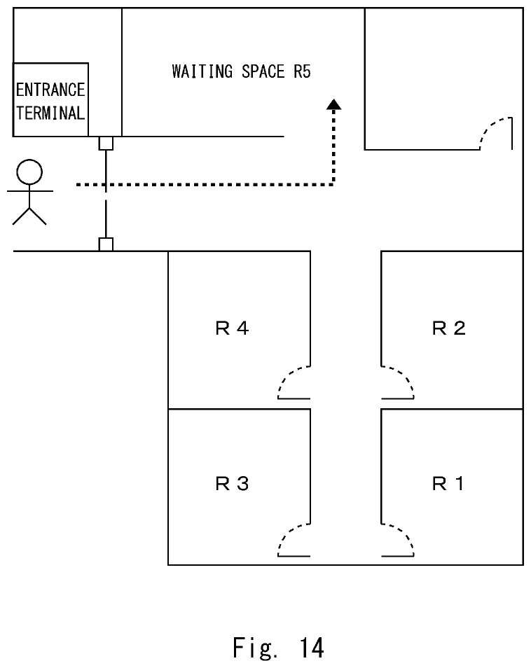

For example, when the guide place is the reserved meeting room R1, the generation unit 116 generates a floor map on which a route from the place where the entrance terminal 500 is installed to the meeting room R1 is indicated (see FIG. 13). On the other hand, when the guide place is the waiting space R5, the generation unit 116 generates a floor map on which a route from the place where the entrance terminal 500 is installed to the waiting space R5 is indicated (see FIG. 14).

After that, the output unit 115 makes (e.g., instructs), for example, the display unit 540 of the entrance terminal 500 display the floor map on which the route from the place where the entrance terminal 500 is installed to the guide place determined by the determination unit 114 is indicated (Step S411).

As described above, the guiding system 800 according to this example embodiment determines (i.e., selects) either one of the reserved meeting room or the waiting space as the guide place based on the reservation information for the meeting in which the visitor is supposed to participate and the arrival time of the visitor, and outputs information about a route to the guide place. In this way, the guiding system 800 according to this example embodiment can not only guide the visitor to the reserved meeting room but also enable the visitor to effectively use his/her spare time.

Note that, in the present disclosure, any of the processes which have been described as been processed by hardware can be implemented, for example, by causing a CPU to execute a computer program(s).

In the above-described examples, the program can be stored and provided to a computer using any type of non-transitory computer readable media. Non-transitory computer readable media include any type of tangible storage media. Examples of non-transitory computer readable media include magnetic storage media (floppy disks, magnetic tapes, hard disk drives), and optical magnetic storage media (e.g., magneto-optical disks). Examples of non-transitory computer readable media also include CD-ROM (Read Only Memory), CD-R, CD-R/W , DVD (Digital Versatile Disc), and semiconductor memories (e.g., mask ROM, PROM (Programmable ROM), EPROM (Erasable PROM), flash ROM, and RAM (Random Access Memory). Further, the program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above-described first and second example embodiments, and they may be changed as appropriate without departing from the scope and spirit of the disclosure. Further, the present disclosure may be implemented by combining example embodiments with one another.

Although the above-described first and second example embodiments have been described by using an example in which the guiding apparatus 100 and the guiding system 800 are applied to a building in which there is a meeting room, the present disclosure is not limited to such examples. The guiding apparatus 100 and the guiding system 800 may be applied to other types of facilities (buildings) such as airports. For example, in the case where the guiding apparatus 100 and the guiding system 800 are applied to an airport, they may determine either one of a boarding gate for an airplane that a visitor (e.g., a passenger) is supposed to get on board or a waiting space as the guide place based on the boarding start time of the airplane the visitor is supposed to get on board and the arrival time of the visitor. Note that, in this case, the waiting space may be a waiting space that can be used by any person, or may be a lounge that can be used only by specific persons. Note that in order to enable the guiding apparatus 100 and the guiding system 800 to guide the visitor (the user) to the lounge, for example, it is necessary that the user's status, in addition to the user ID and the face feature information, is already registered in the face information DB 210 in association with the user ID and the face feature information. Such advance registration can be made by registering a photograph image of the user, information about his/her airline ticket, and information about his/her passport in the face information DB 210 while associating them with each other at the time of the check-in, or by registering a face image of the user as an account in the face information DB 210 prior to the check-in. In this way, the guiding apparatus 100 and the guiding system 800 can guide the visitor, for whom the face authentication has succeeded, to the lounge depending on the status of the visitor. Alternatively, a duty-free shop or a souvenir shop may be used as the guide place instead of the waiting space.

Further, in the first and second example embodiments, cases in which the guiding apparatus 100 and the guiding system 800 determine the waiting space as the guide place when the difference between the start time of the meeting in which the visitor is supposed to participate and the arrival time of the visitor is equal to or longer than the predetermined time have been described as examples. However, the present disclosure is not limited to such examples. When the meeting room for the meeting in which the visitor is supposed to participate is available when the visitor has arrived, the meeting room may be used as one of the choices for the guide place. In this case, a floor map on which both a route to the waiting space and a route to the meeting room are indicated may be displayed, or a floor map on which only one of these routes is indicated may be displayed.

Further, although examples in which a floor map on which a route from the place where the entrance terminal 500 is installed to the guide place is indicated is displayed on the display unit 540 of the entrance terminal 500 have been described in the first and second example embodiments, the present disclosure is not limited to such examples. A display device such as digital signage device may be further provided on the route from the place where the entrance terminal 500 is installed to the guide place, and a floor map on which a route from the place where the display device is installed to the guide place is indicated may be displayed on the display device. Further, the display device may be provided near the elevator hall located on the route from the place where the entrance terminal 500 is installed to the guide place. In this case, on this display device, for example, the floor number of the floor on which the guide place is located, or one (or some) of a plurality of elevators that stops on the floor on which the guide place is located is displayed.

Further, the elevator located on the route to the guide place may be controlled by an elevator control system or the like (not shown) so that the elevator stops on the floor on which the visitor is present when the visitor has approached to the elevator.

Further, notification means for notifying, when the difference between the start time of the meeting in which the visitor is supposed to participate and the visiting time of the visitor becomes shorter than a predetermined time, the visitor of this fact may be provided in the waiting space. This notification means may be, for example, a notification apparatus that notifies the visitor of the above-described information by a voice, or a display device that displays a floor map on which a route from a waiting space to a meeting room is indicated on a monitor.

Further, for a visitor who has been guided to the waiting space, when the difference between the start time of the meeting in which the visitor is supposed to participate and the visiting time of the visitor becomes shorter than a predetermined time, information about this fact may be sent to a user terminal carried by the visitor. Note that, in this case, it is necessary that an e-mail address of the visitor is registered when face feature information of the visitor is registered.

Further, the entrance terminal 500 may include, inside thereof, one or both of the guiding apparatus 100a and the authentication apparatus 200. Further, as described above, the guiding apparatus 100a may include, inside thereof, one or both of the authentication apparatus 200 and the reservation information management apparatus 600.

The whole or part of the example embodiments disclosed above can be described as, but not limited to, the following supplementary notes.

### (Supplementary Note 1)

A guiding apparatus comprising:

acquisition means for acquiring a photograph image of a visitor taken by a photographing apparatus;

face authentication means for performing face authentication on a face area of the visitor extracted from the photograph image acquired by the acquisition means;

specifying means for specifying reservation information for the visitor when the face authentication by the face authentication means has succeeded;

determination means for determining a place to which the visitor should be guided based on the reservation information specified by the specifying means and an arrival time of the visitor; and

output means for outputting information about a route to the place to which the visitor should be guided determined by the determination means.

### (Supplementary Note 2)

The guiding apparatus described in Supplementary note 1, wherein when a difference between a reservation time contained in the reservation information specified by the specifying means and the arrival time of the visitor is shorter than a predetermined time, the determination means determines a reservation place contained in the reservation information as the place to which the visitor should be guided.

### (Supplementary Note 3)

The guiding apparatus described in Supplementary note 1 or 2, wherein when a difference between a reservation time contained in the reservation information specified by the specifying means and the arrival time of the visitor is equal to or longer than a predetermined time, the determination means determines a waiting space as the place to which the visitor should be guided.

### (Supplementary Note 4)

The guiding apparatus described in Supplementary note 1 or 2, wherein when a difference between a reservation time contained in the reservation information specified by the specifying means and the arrival time of the visitor is equal to or longer than a predetermined time, and a reservation place contained in the reservation information specified by the specifying means is available when the visitor arrives, the determination means determines a reservation place contained in the reservation information as the place to which the visitor should be guided.

### (Supplementary Note 5)

The guiding apparatus described in Supplementary note 1 or 2, wherein when a difference between a reservation time contained in the reservation information specified by the specifying means and the arrival time of the visitor is equal to or longer than a predetermined time, and a reservation place contained in the reservation information specified by the specifying means is available when the visitor arrives, the determination means determines each of a waiting space and a reservation place contained in the reservation information as the place to which the visitor should be guided.

### (Supplementary Note 6)

The guiding apparatus described in any one of Supplementary notes 1 to 5, wherein the output means is configured to, when the face authentication of the visitor by the face authentication means has failed, notify the visitor that the face authentication has failed.

### (Supplementary Note 7)

The guiding apparatus described in any one of Supplementary notes 1 to 6, wherein

the reservation information is reservation information for a meeting room, and

the determination means is configured to determine the place to which the visitor should be guided based on a difference between a start time of a meeting in which the visitor is supposed to participate and an arrival time of the visitor at a building in which the meeting room is located, the start time of the meeting being contained in the reservation information specified by the specifying means.

### (Supplementary Note 8)

The guiding apparatus described in any one of Supplementary notes 1 to 6, wherein

the reservation information is reservation information for an airplane which the visitor is supposed to get on board, and

the determination means is configured to determine the place to which the visitor should be guided based on a difference between a boarding start time of the airplane and an arrival time of the visitor at an airport, the boarding start time being contained in the reservation information specified by the specifying means.

### (Supplementary Note 9)

The guiding apparatus described in any one of Supplementary notes 1 to 8, wherein the face authentication means makes an authentication apparatus, in which a plurality of pieces of face feature information of a plurality of users contained in the reservation information are stored, perform face authentication for the visitor by comparing face feature information of the visitor extracted from the photograph image acquired by the acquisition means with each of the plurality of pieces of face feature information of the plurality of users stored in the authentication apparatus.

### (Supplementary Note 10)

The guiding apparatus described in any one of Supplementary notes 1 to 8, further comprising storage means for storing a plurality of pieces of face feature information of a plurality of users contained in the reservation information, wherein

the face authentication means performs face authentication for the visitor by comparing face feature information of the visitor extracted from the photograph image acquired by the acquisition means with each of the plurality of pieces of face feature information of the plurality of users stored in the storage means.

### (Supplementary Note 11)

A guiding system comprising:

an entrance terminal comprising at least photographing means and display means; and

a guiding apparatus described in Supplementary note 1, wherein

in the guiding apparatus, the acquisition means is configured to acquire a photograph image of a visitor taken by the photographing means provided in the entrance terminal, and

the output means is configured to make the display means, which is provided in the entrance terminal, display information about a route to the place to which the visitor should be guided determined by the determination means.

### (Supplementary Note 12)

The guiding system described in Supplementary note 11, wherein when a difference between a reservation time contained in the reservation information specified by the specifying means and the arrival time of the visitor is shorter than a predetermined time, the determination means determines a reservation place contained in the reservation information as the place to which the visitor should be guided.

### (Supplementary Note 13)

The guiding system described in Supplementary note 11 or 12, wherein when a difference between a reservation time contained in the reservation information specified by the specifying means and the arrival time of the visitor is equal to or longer than a predetermined time, the determination means determines a waiting space as the place to which the visitor should be guided.

### (Supplementary Note 14)

The guiding system described in Supplementary note 11, wherein

the determination means is configured to determine a reservation place contained in the reservation information as the place to which the visitor should be guided when a difference between a reservation time contained in the reservation information specified by the specifying means and the arrival time of the visitor is shorter than a predetermined time, and to determine a waiting space as the place to which the visitor should be guided when the difference between the reservation time contained in the reservation information specified by the specifying means and the arrival time of the visitor is equal to or longer than the predetermined time, and

in the waiting space, notification means for notifying, when the difference between the reservation time contained in the reservation information specified by the specifying means and the visiting time of the visitor becomes shorter than a predetermined time, the visitor that the difference becomes shorter than the predetermined time is provided.

### (Supplementary Note 15)

A guiding method comprising:

an acquisition step of acquiring a photograph image of a visitor taken by a photographing apparatus;

a face authentication step of performing face authentication on a face area of the visitor extracted from the photograph image acquired in the acquisition step;

a specifying step of specifying reservation information for the visitor when the face authentication has succeeded in the face authentication step;

a determination step of determining a place to which the visitor should be guided based on the reservation information specified in the specifying step and an arrival time of the visitor; and

an outputting step of outputting information about a route to the place to which the visitor should be guided determined in the determination step.

### (Supplementary Note 16)

The guiding method described in Supplementary note 15, wherein in the determination step, when a difference between a reservation time contained in the reservation information specified in the specifying step and the arrival time of the visitor is shorter than a predetermined time, a reservation place contained in the reservation information is determined as the place to which the visitor should be guided.

### (Supplementary Note 17)

The guiding method described in Supplementary note 15 or 16, wherein in the determination step, when a difference between a reservation time contained in the reservation information specified in the specifying step and the arrival time of the visitor is equal to or longer than a predetermined time, a waiting space is determined as the place to which the visitor should be guided.

### (Supplementary Note 18)

A non-transitory computer readable medium storing a guiding program for causing a computer to perform:

an acquisition process for acquiring a photograph image of a visitor taken by a photographing apparatus;

a face authentication process for performing face authentication on a face area of the visitor extracted from the photograph image acquired in the acquisition process;

a specifying process for specifying reservation information for the visitor when the face authentication has succeeded in the face authentication process;

a determination process for determining a place to which the visitor should be guided based on the reservation information specified in the specifying process and an arrival time of the visitor; and

an outputting process for outputting information about a route to the place to which the visitor should be guided determined in the determination process.

### (Supplementary Note 19)

The non-transitory computer readable medium described in Supplementary note 18, wherein in the determination process, when a difference between a reservation time contained in the reservation information specified in the specifying process and the arrival time of the visitor is shorter than a predetermined time, a reservation place contained in the reservation information is determined as the place to which the visitor should be guided.

### (Supplementary Note 20)

The non-transitory computer readable medium described in Supplementary note 18 or 19, wherein in the determination process, when a difference between a reservation time contained in the reservation information specified in the specifying process and the arrival time of the visitor is equal to or longer than a predetermined time, a waiting space is determined as the place to which the visitor should be guided.

Although the present invention is described above with reference to example embodiments, the present invention is not limited to the above-described example embodiments.

Various modifications that can be understood by those skilled in the art can be made to the configuration and details of the present invention within the scope of the invention.

### REFERENCE SIGNS LIST

100 GUIDING APPARATUS

100a GUIDING APPARATUS

110 CONTROL UNIT

111 ACQUISITION UNIT

112 FACE AUTHENTICATION UNIT

113 SPECIFYING UNIT

114 DETERMINATION UNIT

115 OUTPUT UNIT

116 GENERATING UNIT

120 STORAGE UNIT

130 MEMORY

140 COMMUNICATION UNIT

200 AUTHENTICATION APPARATUS

210 FACE INFORMATION DB

220 FACE DETECTION UNIT

230 FEATURE POINT EXTRACTION UNIT

240 REGISTRATION UNIT

250 AUTHENTICATION UNIT

300 FACE AUTHENTICATION TERMINAL

310 PHOTOGRAPHING UNIT

320 STORAGE UNIT

330 COMMUNICATION UNIT

340 DISPLAY UNIT

350 CONTROL UNIT

351 PHOTOGRAPHING CONTROL UNIT

352 REGISTRATION REQUEST UNIT

400 USER TERMINAL

410 PHOTOGRAPHING UNIT

420 STORAGE UNIT

430 COMMUNICATION UNIT

440 DISPLAY UNIT

450 CONTROL UNIT

451 PHOTOGRAPHING CONTROL UNIT

452 REGISTRATION REQUEST UNIT

500 ENTRANCE TERMINAL

510 PHOTOGRAPHING UNIT

520 STORAGE UNIT

530 COMMUNICATION UNIT

540 DISPLAY UNIT

550 CONTROL UNIT

551 PHOTOGRAPHING CONTROL UNIT

552 OUTPUT CONTROL UNIT

600 RESERVATION INFORMATION MANAGEMENT APPARATUS

610 STORAGE UNIT

620 COMMUNICATION UNIT

630 CONTROL UNIT

631 REGISTRATION UNIT

632 OUTPUT CONTROL UNIT

700 NETWORK

800 GUIDING SYSTEM

What is claimed is:

1. A guiding apparatus comprising:
at least one memory storing program instructions; and
at least one processor configured to execute the instructions stored in the memory to:
acquire a photograph image of a visitor taken by a photographing apparatus;
perform face authentication on a face area of the visitor extracted from the photograph image;
specify reservation information for the visitor when the face authentication has succeeded;
determine a place to which the visitor should be guided based on the specified reservation information and an arrival time of the visitor; and
output information about a route to the determined place to which the visitor should be guided.

2. The guiding apparatus according to claim 1, wherein in the determination of the place to which the visitor should be guided, when a difference between a reservation time contained in the specified reservation information and the arrival time of the visitor is shorter than a predetermined time, a reservation place contained in the reservation information is determined as the place to which the visitor should be guided.

3. The guiding apparatus according to claim 1, wherein in the determination of the place to which the visitor should be guided, when a difference between a reservation time contained in the specified reservation information and the arrival time of the visitor is equal to or longer than a predetermined time, a waiting space is determined as the place to which the visitor should be guided.

4. The guiding apparatus according to claim 1, wherein in the determination of the place to which the visitor should be guided, when a difference between a reservation time contained in the specified reservation information and the arrival time of the visitor is equal to or longer than a predetermined time, and a reservation place contained in the specified reservation information is available when the visitor arrives, the reservation place contained in the reservation information is determined as the place to which the visitor should be guided.

5. The guiding apparatus according to claim 1, wherein in the determination of the place to which the visitor should be guided, when a difference between a reservation time contained in the specified reservation information and the arrival time of the visitor is equal to or longer than a predetermined time, and a reservation place contained in the specified reservation information is available when the visitor arrives, each of a waiting space and a reservation place contained in the reservation information is determined as the place to which the visitor should be guided.

6. The guiding apparatus according to claim 1, wherein in the outputting of the information about the route, when the face authentication of the visitor has failed, information about the fact that the face authentication has failed is output.

7. The guiding apparatus according to claim 1, wherein
the reservation information is reservation information for a meeting room, and
in the determination of the place to which the visitor should be guided, the place to which the visitor should be guided is determined based on a difference between a start time of a meeting in which the visitor is supposed to participate and an arrival time of the visitor at a building in which the meeting room is located, the start time of the meeting being contained in the specified reservation information.

8. The guiding apparatus according to claim 1, wherein
the reservation information is reservation information for an airplane which the visitor is supposed to get on board, and
in the determination of the place to which the visitor should be guided, the place to which the visitor should be guided is determined based on a difference between a boarding start time of the airplane and an arrival time of the visitor at an airport, the boarding start time being contained in the specified reservation information.

9. The guiding apparatus according to claim 1, wherein in the performing of the face authentication, an authentication apparatus, in which a plurality of pieces of face feature information of a plurality of users contained in the reservation information are stored, is made to perform face authentication for the visitor by comparing face feature information of the visitor extracted from the photograph image with each of the plurality of pieces of face feature information of the plurality of users stored in the authentication apparatus.

10. The guiding apparatus according to claim 1, wherein
the at least one processor is further configured to execute the instructions stored in the memory to store a plurality of pieces of face feature information of a plurality of users contained in the reservation information, and
in the performing of the face authentication, face authentication for the visitor is performed by comparing face feature information of the visitor extracted from the photograph image with each of the plurality of pieces of face feature information of the plurality of users.

11. A guiding system comprising:
an entrance terminal comprising at least a photographing apparatus and a display device; and
a guiding apparatus according to claim 1, wherein
in the guiding apparatus, in the acquisition of the photograph image of the visitor, a photograph image of a visitor taken by the photographing apparatus provided in the entrance terminal is acquired, and
in the outputting of the information about the route, display information about a route to the determined place to which the visitor should be guided is output to the display device provided in the entrance terminal.

12. The guiding system according to claim 11, wherein in the determination of the place to which the visitor should be guided, when a difference between a reservation time contained in the specified reservation information and the arrival time of the visitor is shorter than a predetermined time, a reservation place contained in the reservation information is determined as the place to which the visitor should be guided.

13. The guiding system according to claim 11, wherein in the determination of the place to which the visitor should be guided, when a difference between a reservation time contained in the specified reservation information and the arrival time of the visitor is equal to or longer than a predetermined time, a waiting space is determined as the place to which the visitor should be guided.

14. The guiding system according to claim 11, wherein
in the determination of the place to which the visitor should be guided, a reservation place contained in the reservation information is determined as the place to which the visitor should be guided when a difference between a reservation time contained in the specified reservation information and the arrival time of the visitor is shorter than a predetermined time, and a waiting space is determined as the place to which the visitor should be guided when the difference between the reservation time contained in the specified reservation information and the arrival time of the visitor is equal to or longer than the predetermined time, and
the at least one processor is further configured to execute the instructions stored in the memory to notify, in the waiting space, when the difference between the reservation time contained in the specified reservation information and the visiting time of the visitor becomes shorter than a predetermined time, the visitor that the difference becomes shorter than the predetermined time.

15. A guiding method comprising:
acquiring a photograph image of a visitor taken by a photographing apparatus;
performing face authentication on a face area of the visitor extracted from the photograph image;
specifying reservation information for the visitor when the face authentication has succeeded;
determining a place to which the visitor should be guided based on the specified reservation information and an arrival time of the visitor; and
outputting information about a route to the determined place to which the visitor should be guided.

16. The guiding method according to claim 15, wherein in the determination of the place to which the visitor should be guided, when a difference between a reservation time contained in the specified reservation information and the arrival time of the visitor is shorter than a predetermined time, a reservation place contained in the reservation information is determined as the place to which the visitor should be guided.

17. The guiding method according to claim 15, wherein in the determination step in the determination of the place to which the visitor should be guided, when a difference between a reservation time contained in the specified reservation information and the arrival time of the visitor is equal to or longer than a predetermined time, a waiting space is determined as the place to which the visitor should be guided.

18. A non-transitory computer readable medium storing a guiding program for causing a computer to perform:
an acquisition process for acquiring a photograph image of a visitor taken by a photographing apparatus;
a face authentication process for performing face authentication on a face area of the visitor extracted from the photograph image acquired in the acquisition process;
a specifying process for specifying reservation information for the visitor when the face authentication has succeeded in the face authentication process;
a determination process for determining a place to which the visitor should be guided based on the reservation information specified in the specifying process and an arrival time of the visitor; and
an outputting process for outputting information about a route to the place to which the visitor should be guided determined in the determination process.

19. The non-transitory computer readable medium according to claim 18, wherein in the determination process, when a difference between a reservation time contained in the reservation information specified in the specifying process and the arrival time of the visitor is shorter than a predetermined time, a reservation place contained in the reservation information is determined as the place to which the visitor should be guided.

20. The non-transitory computer readable medium according to claim 18, wherein in the determination process, when a difference between a reservation time contained in the reservation information specified in the specifying process and the arrival time of the visitor is equal to or longer than a predetermined time, a waiting space is determined as the place to which the visitor should be guided.
